(19) United States
(12) Patent Application Publication
(10) Pub. No.: US 2017/0059866 A1
(43) Pub. Date: Mar. 2, 2017

(54) DISPLAY DEVICE, FOR A MOTOR VEHICLE

(71) Applicant: JOHNSON CONTROLS AUTOMOTIVE ELECTRONICS SAS, Cergy Pontoise Cedex (FR)

(72) Inventors: Fabrice HENON, Cergy (FR); Yves LAMBERT, Osny (FR); Nicolas LOUVIEAUX, Parnes (FR)

(21) Appl. No.: 15/300,788

(22) PCT Filed: Apr. 2, 2015
(86) PCT No.: PCT/EP2015/057425

§ 371 Date: Nov. 14, 2016

(30) Foreign Application Priority Data
Apr. 3, 2014 (EP) 14163428.7

(51) Int. Cl. G02B 27/01; B60K 35/00; B60R 1/00

(52) U.S. Cl. CPC G02B 27/0149; B60R 1/00; B60K 35/00; G02B 27/0101; B60R 2300/205; G02B 2027/0154; G02B 2027/0163; G02B 2027/0169

(57) ABSTRACT

A display device for a motor vehicle includes: a projection module, configured to generate an image for projection in a normal direction of view of a user of the display device in an optical path; a reflector and/or display, configured to be displaced between a rest position and at least one display position by a support, wherein the rest position of the reflector and/or display corresponds to a rest positioning state of the support, and wherein the at least one display position corresponds to a display positioning state of the support and a housing, wherein the reflector and/or display and the support are positioned inside the housing in the rest position and the rest positioning state, and at least partially, outside the housing in the at least one display position. The housing comprises a service opening and a service cover, the service cover covering the service opening.

### CROSS-REFERENCE TO RELATED APPLICATIONS

This application is a U.S. National Phase application under 35 U.S.C. §371 of International Application No. PCT/EP2015/057425, filed on Apr. 2, 2015, and claims benefit to European Patent Application No. EP 14163428.7, filed on Apr. 3, 2014. The International Application was published in French on Oct. 8, 2015 as WO 2015/150569 A1 under PCT Article 21(2).

### FIELD

The present invention relates to a display device, in particular for a motor vehicle.

### BACKGROUND

Display devices of the head up display (HUD) type are known, in particular including the projection of an image towards a windscreen as described in U.S. Pat. No. 5,214,413 or towards a reflection element.

Head up display devices permit information to be projected into the field of view in the space in front of the vehicle so that the driver of the motor vehicle can read this information without taking his/her eyes from the space in front of the motor vehicle. At the same time, the information can be read without changing the accommodation of the eyes of the driver of the vehicle.

It is advantageous that—depending on the needs of a user of the vehicle—the reflection and/or display element can be used in a plurality of positions of the head (or eyes) of the user of the vehicle.

A disadvantage of such devices in the prior art consists of the fact that the effort required in changing the reflection and/or display element can be considerable. US 2011/0242668 A1 proposes modifying the movement of the reflection and/or display element, which gives rise to high costs for the display device.

### SUMMARY

In an embodiment, the present invention provides a display device for a motor vehicle. The display device includes: a projection module, configured to generate an image for projection in a normal direction of view of a user of the display device in an optical path; a reflector and/or display, configured to be displaced between a rest position and at least one display position by a support, wherein the rest position of the reflector and/or display corresponds to a rest positioning state of the support, and wherein the at least one display position corresponds to a display positioning state of the support; and a housing, wherein the reflector and/or display and the support are positioned inside the housing in the rest position and the rest positioning state, and wherein the reflector and/or display is positioned, at least partially, outside the housing in the at least one display position, and wherein the housing comprises a service opening and a service cover, the service cover being configured to cover the service opening.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic cross-sectional view of a display device in accordance with the present invention.

FIG. 2 is a schematic view of a display device in accordance with the present invention with the reflector and/or display in its display position.

FIG. 3 is a schematic view of the display device in accordance with the present invention with the reflector and/or display in its rest position.

FIGS. 4 to 6 are schematic views of the display device in accordance with the present invention with the service cover in an open position.

### DESCRIPTION OF THE DRAWINGS

Exemplary embodiments of the present invention overcome the disadvantages of the prior art, and in particular those mentioned above, and also provide a head up display device having a reflector and/or display which can easily be changed.

In an exemplary embodiment, the invention provides a display device, in particular for a motor vehicle, comprising a projection module to generate an image for projection in the normal direction of view of a user of the display device in an optical path, the display device comprising a reflector and/or display, the reflector and/or display being able to be displaced between a rest position and at least one display position, the display device comprising a support for the reflector and/or display such that the reflector and/or display is displaced between its rest position and at least one display position by the support, the rest position of the reflector and/or display corresponding to a rest positioning state of the support of the reflector and/or display, and the display position of the reflector and/or display corresponding to a display positioning state of the support of the reflector and/or display, the display device also comprising a housing such that the reflector and/or display and the support thereof are positioned inside the housing in their rest positions, and that the reflector and/or display is positioned, at least partially, outside the housing in at least one display position, the housing comprising a service opening and a service cover, the service cover covering the service opening.

According to this exemplary embodiment of a display device, it is advantageously possible to carry out a change of the reflector and/or display in a simple manner in a short time and for little expense.

Another preferred improvement of the invention provides that the housing also comprises a display opening and a display cover, the reflector and/or display exiting the housing when it is driven in at least one display position.

According to this exemplary embodiment of a display device, it is advantageously possible to produce an aesthetic aspect of the display device without providing an excessively large display opening which is visible when the reflector and/or display is positioned in its display position (or in one display position among a plurality of display positions).

Another preferred improvement of the invention provides that the reflector and/or display can be changed by opening the service cover.

According to this exemplary embodiment of a display device, it is advantageously possible to avoid having to provide for modified movement of the reflector and/or display simply to change the reflector and/or display. By opening the service cover it is advantageously possible to gain access to the fixing arrangement between the reflector and/or display and the support of the reflector and/or display, and it is thus easily possible to change the reflector and/or display.

According to one variation of the present invention, it is also preferred that the reflector and/or display can be changed in a manner isolated from the rest of the display device.

Thus, it is advantageously possible, in accordance with the invention, for the cost of changing the reflector and/or display to be reduced considerably.

One preferred improvement of the invention provides that the reflector and/or display can be positioned in a plurality of different display positions.

One preferred improvement of the invention provides that between the different display positions of the reflector and/or display, the reflector and/or display is subjected to a rotary and/or translational movement.

Another preferred improvement of the invention provides that the reflector and/or display is driven between its rest position and at least one display position using a motor.

Other features and advantages of the invention will be apparent upon reading the following description of a particular, non-limiting embodiment of the present invention.

As shown in FIG. 1, a display device 10 in accordance with the present invention comprises a projection module 11 which generates an image in the normal direction of view 15 of a user of the display device 10 in an optical path 12.

The optical path 12 normally comprises at least one reflector and/or display 13. In this way, the optical path 12 can comprise a (single) reflector as shown in FIG. 1. Moreover, the optical path 2 can also comprise two reflectors. The display device 10 can also be produced with either a reflector 13 or with a display (such as for example a thin film transistor, TFT) or with a reflector and display.

The normal direction of view 15 is the viewing direction of a user of the display device 10, in particular a vehicle driver, when this person is looking, in particular through a windscreen 14, at the outside area in front of the vehicle.

In accordance with the present invention, the reflector and/or display 13 is an element positioned spaced apart from the windscreen 14. In accordance with a preferred embodiment of the present invention, the reflector and/or display 13 can be positioned in a rest position and in at least one display position. When the reflector and/or display 13 is positioned in its rest position, the reflector and/or display 13 is e.g. positioned inside a housing of the display device 10.

When the reflector and/or display 13 is positioned in its display position, the reflector and/or display 13 is typically positioned upright or virtually vertically so that the user of the display device can look through the reflector and/or display 13. The change in position from the rest position to the display position of the reflector and/or display 13 is carried out by a rotational and/or translational movement.

Different positions of the reflector and/or display 13 can correspond to different display positions and adapted to different heights of the head of the user. The reflector and/or display 13 is typically driven by a motor, either directly or via a transmission. The motor can in particular be a linear motor or a rotational motor, in particular an electric stepping motor.

In accordance with the present invention, a support is associated with the reflector and/or display 13. The support can be driven between different positioning states, in particular via the motor.

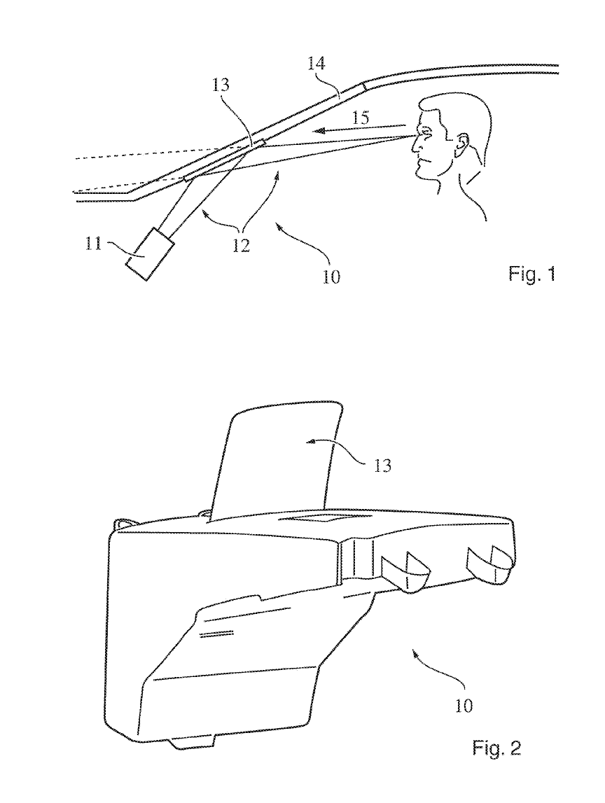

FIG. 2 shows a schematic view of a display device 10 in accordance with the present invention. The display device 10 comprises the reflector and/or display 13 in its display position.

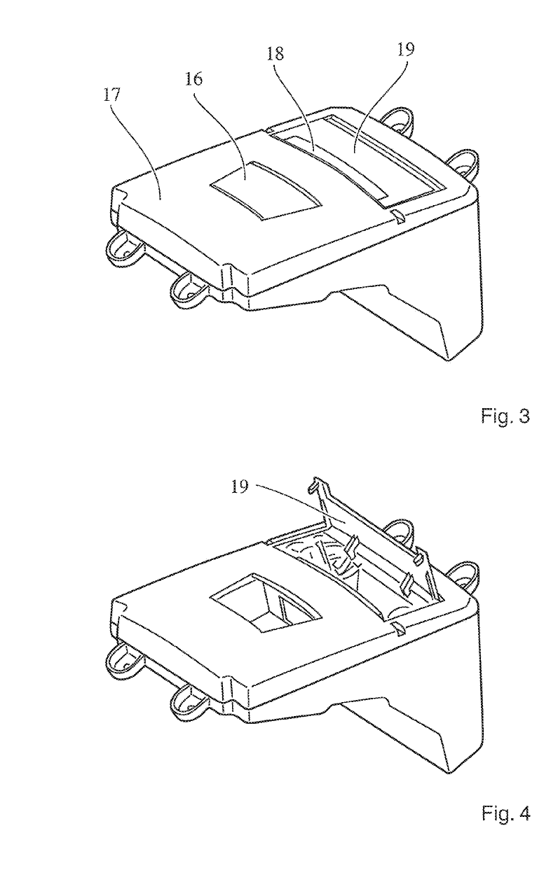

FIG. 3 shows a schematic view of a display device 10 in accordance with the present invention. The reflector and/or display 13 is in its rest position. The display device 10 comprises a housing 17 which comprises an optical cover 16, a display cover 18 and a service cover 19.

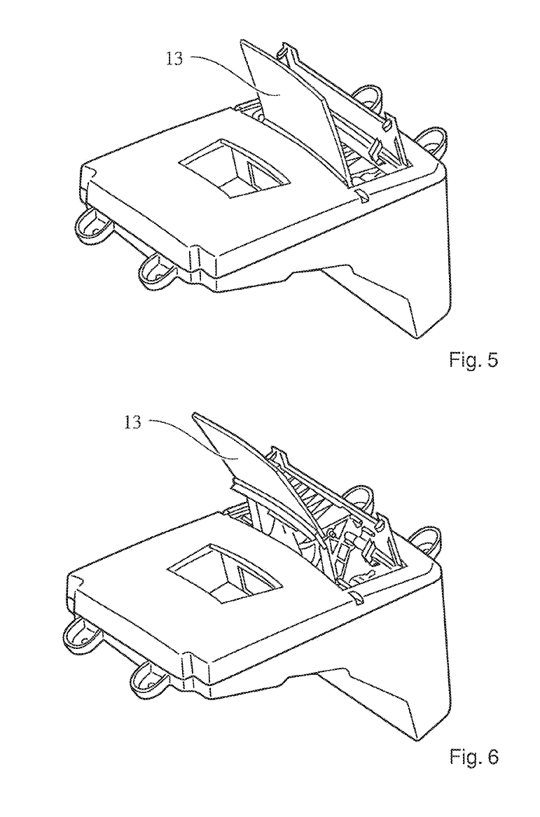

FIGS. 4 to 6 show schematic views of the display device 10 in accordance with the present invention, with the service cover 19 in an open position in which the service cover 19 releases a service opening of the housing 17. As shown in FIGS. 5 and 6, the reflector and/or display 13 can be moved out—at least partially with or without the aid of the motor—of the housing 17 of the display device 10 so as to be able to change the reflector and/or display 13.

In accordance with the present invention, the support of the reflector and/or display 13 can comprise a service lever, with the aid of which the reflector and/or display 13 can be fixed to, or detached from, the support of the reflector and/or display 13. When the service lever is in its fixing position, the reflector and/or display 13 is attached to its support. When the service lever is in its open position, the reflector and/or display 13 can be detached from its support.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 display device
11 projection module
12 optical path
13 reflector and/or display
14 windscreen
15 normal direction of view
16 optical cover
17 housing
18 display cover
19 service cover

1. A display device for a motor vehicle, comprising:
a projection module, configured to generate an image for projection in a normal direction of view of a user of the display device in an optical path;
reflector and/or display, configured to be displaced between a rest position and at least one display position by a support, wherein the rest position of the reflector and/or display corresponds to a rest positioning state of the support, and wherein the at least one display position corresponds to a display positioning state of the support; and
a housing, wherein the reflector and/or display and the support are positioned inside the housing in the rest position and the rest positioning state, and wherein the reflector and/or display is positioned, at least partially, outside the housing in the at least one display position, and wherein the housing comprises a service opening and a service cover, the service cover being configured to cover the service opening.

2. The display device according to claim 1, wherein the housing further comprises a display opening and a display cover, the reflector and/or display being configured to exit the housing through the display opening when the reflector and/or display is driven to the at least one display position from the rest position.

3. The display device according to claim 1, wherein the reflector and/or display is configured to be removed for changing by opening the service cover.

4. The display device according to claim 1, wherein the reflector and/or display is configured to be positioned in a plurality of different display positions.

5. The display device according to claim 5, wherein the reflector and/or display is configured to be subjected to a rotary and/or translational movement to be moved between the different display positions of the reflector and/or display.

6. The display device according to claim 1, wherein the reflector and/or display is configured to be driven between the rest position. and the at least one display position by a motor.

7. The display device according to claim 1, wherein the reflector and/or display is configured to be removed for changing in a manner isolated from the rest of the display device.
